(19) United States
(12) Patent Application Publication
(10) Pub. No.: US 2024/0066871 A1
(43) Pub. Date: Feb. 29, 2024

(54) METHOD FOR MANUFACTURING FLOW PATH MEMBER

(71) Applicant: CANON KABUSHIKI KAISHA, Tokyo (JP)

(72) Inventors: KENJI TAMAMORI, Kanagawa (JP); TETSUSHI ISHIKAWA, Tokyo (JP); MITSUNORI TOSHISHIGE, Kanagawa (JP)

(21) Appl. No.: 18/456,870

(22) Filed: Aug. 28, 2023

(30) Foreign Application Priority Data
Aug. 30, 2022 (JP) 2022-136399
Jun. 13, 2023 (JP) 2023-097285

(51) Int. Cl. B41J 2/16; B41J 2/14

(52) U.S. Cl. CPC B41J 2/1623; B41J 2/14274; B41J 2/1626; B41J 2202/03; B41J 2202/22

(57) ABSTRACT

A method for manufacturing a flow path member includes bringing a flexible member into contact with a first substrate including a recessed portion via an adhesive agent so as to cover the recessed portion, wherein the flexible member is configured to suppress vibrations of a liquid in a flow path, curing the adhesive agent in a state where at least an area of the flexible member covering the recessed portion is supported by a support member, bonding a second substrate to a side of the first substrate with which the flexible member is brought into contact, wherein the second substrate is configured to form the flow path facing the flexible member, and removing the support member from the flexible member in a period after the curing and before the bonding.

### BACKGROUND OF THE INVENTION

### Field of the Invention

The present disclosure relates to a method for manufacturing a flow path member.

### Description of the Related Art

Japanese Patent Application Laid-open No. 2008-110571 discusses a liquid discharge head including a damper film covering an opening to suppress crosstalk. The liquid discharge head is manufactured by forming the resin damper film on a substrate and then forming the opening in the substrate. The opening is formed by etching the substrate to a depth reaching the damper film from a back surface of the substrate.

The liquid discharge head discussed in Japanese Patent Application Laid-open No. 2008-110571 may cause film reduction or breakage of the damper film due to etching at the opening bottom as the etching end point because the opening is formed by etching after the damper film is formed.

To address this, a method of forming an opening in a substrate first and then forming a damper film on the substrate to cover the opening can be conceived to suppress the film reduction or breakage of the damper film. However, if heat treatment is performed to form the resin damper film, the damper film covering the opening may deform because of cure shrinkage or softening caused by the heat.

### SUMMARY OF THE INVENTION

The present disclosure is directed to a method for manufacturing a flow path member while suppressing generation of wrinkles on a flexible member that is arranged to cover a recessed portion.

According to an aspect of the present disclosure, a method for manufacturing a flow path member includes bringing a flexible member into contact with a first substrate including a recessed portion via an adhesive agent so as to cover the recessed portion, wherein the flexible member is configured to suppress vibrations of a liquid in a flow path, curing the adhesive agent in a state where at least an area of the flexible member covering the recessed portion is supported by a support member, bonding a second substrate to a side of the first substrate with which the flexible member is brought into contact, wherein the second substrate is configured to form the flow path facing the flexible member, and removing the support member from the flexible member in a period after the curing and before the bonding.

Further features of the present disclosure will become apparent from the following description of exemplary embodiments with reference to the attached drawings.

### BRIEF DESCRIPTION OF THE DRAWINGS

FIGS. 1A to 1H are cross-section diagrams illustrating a method for manufacturing a flow path member according to a first exemplary embodiment. More specifically, FIG. 1A is a cross-section diagram of a substrate including an opening and a flow path through which a liquid flows, FIG. 1B is a schematic diagram illustrating a process of applying a polyamic acid solution to an attaching member, FIG. 1C is a schematic diagram illustrating a process of attaching a polyamic acid film onto the substrate, FIG. 1D is a schematic diagram illustrating a process of heating the polyamic acid film in a state of being supported by a support member, FIG. 1E is a schematic diagram illustrating a process of removing the support member, FIG. 1F is a schematic diagram illustrating a process of forming an etching mask for a polyimide film, FIG. 1G is a schematic diagram illustrating a state where the etching mask is removed by photolithography, and FIG. 1G is a schematic diagram illustrating a process of removing the polyimide film on a first flow path.

FIG. 2 is a cross-section diagram illustrating a method for manufacturing the flow path member using the attaching member as the support member.

FIG. 3 is a cross-section diagram illustrating a method for manufacturing the flow path member by supporting the polyamic acid film using the support member on a vertically lower side thereof.

FIG. 4 is a cross-section diagram illustrating a method for manufacturing the flow path member using the support member having groove portions.

FIG. 5 is a schematic cross-section diagram illustrating a liquid discharge head including the flow path member according to the first exemplary embodiment.

FIGS. 6A to 6H are cross-section diagrams illustrating a method for manufacturing a flow path member according to a second exemplary embodiment. More specifically, FIG. 6A is a cross-section diagram of a substrate including an opening and a flow path through which a liquid flows, FIG. 6B is a schematic diagram illustrating a process of forming a polyimide film on an attaching member, FIG. 6C is a schematic diagram illustrating a process of bringing the polyimide film into contact with the substrate, FIG. 6D is a schematic diagram illustrating a process of heating the polyimide film in a state of being supported by a support member, FIG. 6E is a schematic diagram illustrating a process of removing the support member, FIG. 6F is a schematic diagram illustrating a process of forming an etching mask for the polyimide film, FIG. 6G is a schematic diagram illustrating a state where the etching mask is removed by photolithography, and FIG. 6H is a schematic diagram illustrating a process of removing the polyimide film on a first flow path.

FIGS. 7A to 7G are cross-section diagrams illustrating a method for manufacturing a flow path member according to a third exemplary embodiment. More specifically, FIG. 7A is a cross-section diagram illustrating a substrate including an opening and a flow path through which a liquid flows, FIG. 7B is a schematic diagram illustrating a process of applying an adhesive agent to an area of a first substrate to which a polyimide film is to be attached, FIG. 7C is a schematic diagram illustrating a process of bringing a flexible member into contact with the first substrate, FIG. 7D is a schematic diagram illustrating a process of forming an etching mask on a second substrate, FIG. 7E is a schematic diagram illustrating a process of removing the etching mask, FIG. 7F is a schematic diagram illustrating a process of forming a second flow path, and FIG. 7G is a schematic diagram illustrating a process of removing the etching mask remaining on the second substrate.

FIG. 8 is a schematic cross-section diagram illustrating a liquid discharge head including the flow path member according to the third exemplary embodiment.

### DESCRIPTION OF THE EMBODIMENTS

Exemplary embodiments of the present disclosure will be described below with reference to the attached drawings. The exemplary embodiments described below are not intended to limit the scope of the present disclosure, and not all combinations of features described in the exemplary embodiments are essential to the solution of the present disclosure. In the drawings, the same reference numerals are assigned to the same components.

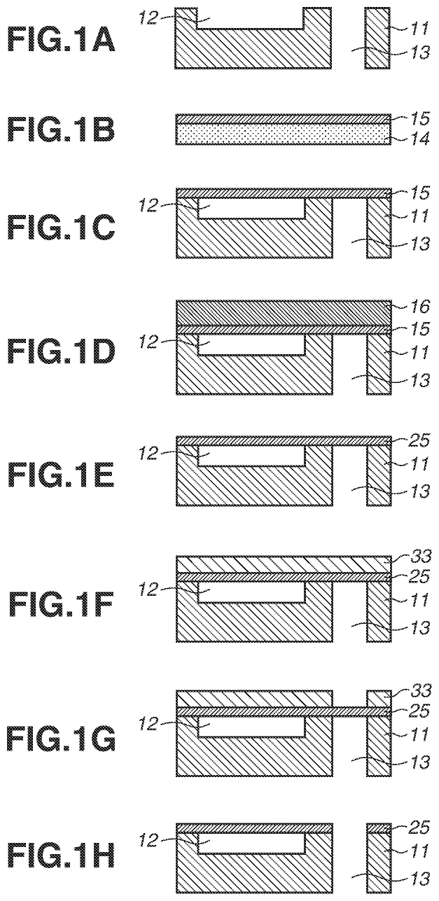

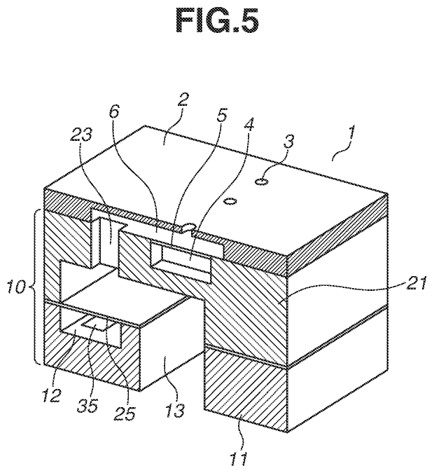

FIGS. 1A to 1H are cross-section diagrams illustrating a method for manufacturing a flow path member 10 (refer to FIG. 5) according to a first exemplary embodiment. First, as illustrated in FIG. 1A, a first substrate 11 including a recessed portion 12 and a first flow path 13 through which a liquid flows is prepared. The first substrate 11 is made of, for example, single crystal silicon, and has dimensions of, for example, 200 millimeters (mm) in diameter and 500 micrometers (μm) in thickness. The recessed portion 12 and the first flow path 13 each have, for example, a rectangular planar shape and, for example, a width of several tens of micrometers to one millimeter in a short-side direction thereof.

In the present exemplary embodiment, the first substrate 11 including the recessed portion 12 and the first flow path 13 is to be prepared. Thus, the recessed portion 12 and the first flow path 13 may be formed in the first substrate 11, or the first substrate 11 where the recessed portion 12 and the first flow path 13 are formed in advance may be purchased. In a case where the recessed portion 12 and the first flow path 13 are to be formed in the first substrate 11, for example, silicon deep dry etching or crystalline anisotropic wet etching can be used.

It is desirable that a silane coupling agent (not illustrated) be applied to a surface (described below) of the first substrate 11 to which a polyamic acid film 15 is to be attached, and then baked. This improves the adhesion between the first substrate 11 and the polyamic acid film 15. The silane coupling agent can be applied using, for example, a spray coat method. The silane coupling agent can be baked using, for example, a clean oven or a hot plate.

Next, as illustrated in FIG. 1B, the polyamic acid film 15 is formed by applying a polyamic acid solution to an attaching member 14 and then baking the polyamic acid solution. The baking is performed to such a degree that a part of the solvent in the polyamic acid solution is dried up and the adhesion of the surface of the polyamic acid film 15 is lost. The polyamic acid solution can be baked, for example, at a temperature between 80° C. and 150° C. using a clean oven or a hot plate. The polyamic acid solution may be baked at a temperature other than that described above, and may be baked in a nitrogen atmosphere.

Polyamic acid (polyamide acid) is a precursor of polyimide, and can be obtained, for example, by reacting aromatic diamine and tetracarboxylic dianhydrides in an organic solvent such as an N-methylpyrrolidone solvent.

The polyamic acid solution can be applied by using, for example, a spin coat method or a slit coat method, but the present exemplary embodiment is not limited thereto. The polyamic acid film 15 is, for example, 5 μm or less in thickness.

For example, the attaching member 14 may be selected from among films of polyimide, polyethylene terephthalate (PET), cycloolefin polymer (COP), and the like, in consideration of heat resistance and the like at the baking temperature. A release material (not illustrated) or release treatment may be applied to the surface of the attaching member 14 to make it easy to separate the polyamic acid film 15 therefrom.

Next, as illustrated in FIG. 1C, the polyamic acid film 15 is attached to the first substrate 11 including the recessed portion 12 so as to cover the recessed portion 12. It is more desirable to attach the polyamic acid film 15 to the first substrate 11 so as to also cover the first flow path 13. In the present exemplary embodiment, the first substrate 11 may be attached to the polyamic acid film 15 instead of attaching the polyamic acid film 15 to the first substrate 11. The attaching process of the polyamic acid film 15 can be performed using an apparatus such as a roller type apparatus capable of pressing and heating or a pressing type apparatus capable of applying a pressure at a surface. The attaching process may be performed in an atmosphere, and more desirably performed in a vacuum because the occurrence of voids between the first substrate 11 and the polyamic acid film 15 can be suppressed.

In a case where the polyamic acid film 15 is formed on the first substrate 11 to cover the recessed portion 12, the recessed portion 12 may not necessarily be sealed, and the first substrate 11 may have, for example, an air communication hole 35 (refer to FIG. 5) for the recessed portion 12 to communicate with the atmosphere. In a case where the first substrate 11 is a silicon substrate, a protection film (not illustrated) may be formed on a front surface of the first substrate 11, a back surface thereof, or inside an opening thereof, depending on the chemical resistance against the liquid in using the first substrate 11 for the flow path member 10.

Next, the polyamic acid film 15 attached to the first substrate 11 is transformed into a polyimide film (a flexible member) 25 for suppressing vibrations of the liquid in a second flow path 23 (refer to FIG. 5) by thermal imidization reaction. At this time, as illustrated in FIG. 1D, an area of the polyamic acid film 15 that is attached to the first substrate 11 and covers at least the recessed portion 12 is heated in a state of being supported by a support member 16, to transform the polyamic acid film 15 on the recessed portion 12 into the polyimide film 25 by thermal imidization reaction. It is desirable for the support member 16 to support the polyimide film 25 on the entire area of the recessed portion 12 to suppress the deformation of the polyimide film 25. It is also desirable to heat an area of the polyamic acid film 15 that is attached to the first substrate 11 and faces the first flow path 13 in a state of being supported by the support member 16. The baking temperature for the imidization is, for example, between 300° C. and 400° C., and the baking can be performed, for example, in a nitrogen atmosphere using a clean oven.

In a case where the heating is performed without using the support member 16, i.e., the heating is performed in a state illustrated in FIG. 1E, the polyamic acid film 15 (the polyimide film 25) softened by the heating may fall into the recessed portion 12. In this case, the polyimide film 25 serving as a damper film becomes deformed. In other words, the damper film (the flexible member) becomes deformed. To address the issue, in the present exemplary embodiment, the support member 16 is attached to the polyamic acid film 15 on the recessed portion 12 and the first flow path 13 to support the polyamic acid film 15. In this way, an adhesive force acts between the polyamic acid film 15 and the support member 16, and the polyamic acid film 15 is constantly pulled toward the support member 16. Because the polyamic acid film 15 is heated (imidized) in a state where the polyimide film 25 is pulled (extended) by the support member 16, it is possible to reduce a risk of generating wrinkles on the polyimide film (the flexible member) 25 to be formed. Because the adhesive force between the support member 16 and the polyamic acid film 15 is larger than the force causing the polyamic acid film 15 to fall into the recessed portion 12, it is also possible to prevent the polyamic acid film 15 from falling into the recessed portion 12. Thus, even if the polyamic acid film 15 is heated at the imidization baking temperature, it is possible to suppress the deformation of the polyamic acid film 15 caused by the heating treatment.

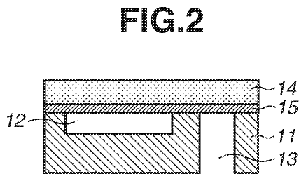

As the support member 16, a member newly prepared as the support member 16 after the attaching member 14 is separated from the polyamic acid film 15 can be used. Alternatively, as illustrated in FIG. 2, the thermal reaction process may be performed in such a manner that the attaching member 14 also serves as the support member 16. In this case, the attaching member 14 is made of a material having a heat resistance property at the imidization baking temperature, and, for example, polyimide can be used as the material of the attaching member 14.

To suppress the deformation of the polyamic acid film 15 and the polyimide film 25 due to the deformation of the support member 16, it is desirable that the glass transition temperature of the support member 16 be higher than the heating temperature in the heating process.

As the difference between the linear expansion coefficient of the support member 16 and the linear expansion coefficient of the polyimide film 25 decreases, the deformation of the polyimide film 25 decreases, which is desirable. For example, the difference between the linear expansion coefficients is desirably 50 parts per million (ppm)/° C. or less, and more desirably 30 ppm/° C. or less.

It is desirable that the Young's modulus of the support member 16 be larger than or equal to the Young's modulus of the polyimide film 25 because the support member 16 can be separated easily from the polyimide film 25 as described below. As the material of the support member 16, for example, a single crystal silicon substrate or a borosilicate glass substrate is desirable if a substrate is employed for the support member 16, and, for example, a polyimide film is desirable if a film is employed for the support member 16.

The support member 16 is desirably thicker than the polyimide film 25 to be formed, from the viewpoint of stiffness. For example, in a case where the thickness of the polyimide film 25 is 5 μm, the thickness of the support member 16 is desirably 30 μm or more. As described below, in a case where the support member 16 is a film, the thickness of the support member 16 is desirably set to, for example, 30 μm or more and 100 μm or less in consideration of the separation of the support member 16. In a case where the support member 16 is a substrate with a diameter of 200 mm, the thickness of the support member 16 is desirably set to, for example, 300 μm or more and 500 μm or less in consideration of the separation of the support member 16. Before a thin substrate as the support member 16 is separated, for example, the support member 16 may be reinforced by a reinforcing member (not illustrated) used for dicing tape or the like. This enables suppressing cracking of the support member 16.

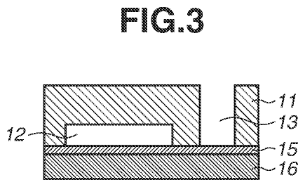

In the heating process, as illustrated in FIG. 3, it is desirable that the polyamic acid film 15 be supported by the support member 16 from vertically below. In this case, even if partial separation occurs between the support member 16 and the polyimide film 25, it is possible to reduce the deformation of the polyimide film 25. In the heating process, the support member 16 supporting the polyimide film 25 from vertically below enables reducing the effect of the gravity force applied to the polyamic acid film 15 and the polyimide film 25, thereby suppressing the deformation of the polyimide film 25.

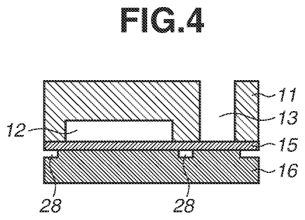

In the process of heating the polyamic acid film 15, the polyamic acid is transformed into the polyimide film 25 by thermal imidization reaction. In this way, the polyimide film 25 can be formed on the first substrate 11. In the thermal imidization process, an out-gas including water and an organic solvent is generated. In general, the out-gas refers to a gas generated when stress such as heat is applied to a material. Accordingly, as illustrated in FIG. 4, the support member 16 desirably has groove portions 28 on a part of a surface thereof in contact with the polyamic acid film 15. With this configuration, the out-gas generated due to the imidization can be discharged through the groove portions 28 of the support member 16. The groove portions 28 can be formed by, for example, performing an etching process on the support member 16. The depth of each of the groove portions 28 is desirably, for example, about 1 μm to 10 μm. The width of each of the groove portions 28 can be determined based on the layout of the recessed portion 12 and the first flow path 13, and the positioning accuracy of the support member 16. The formation of the groove portions 28 enables suppressing the deformation of the polyimide film 25 during the imidization, and reducing the contact area between the support member 16 and the polyimide film 25. This makes it easier to separate the support member 16 from the polyimide film 25.

Next, as illustrated in FIG. 1E, the support member 16 is removed from the polyimide film 25. In this way, the flow path member 10 in which the polyimide film 25 is arranged to cover the recessed portion 12 can be obtained. The support member 16 can be removed using, for example, dry etching, wet etching, grinding, or the separation of the support member 16 from the polyimide film 25.

In a case where the support member 16 is removed by the etching process, it is possible to reduce the risk of damaging the polyimide film (the flexible film) 25, compared with a case where the support member 16 is removed by separation or grinding. In particular, the wet etching can simultaneously process one lot and the etching speed is high. Accordingly, the wet etching is desirable because the wet etching has an advantage of being able to shorten the process time. The process can be performed in an atmospheric environment, and thus the influence of damage to the polyimide film (the flexible member) 25 due to the pressure difference is little. In particular, the dry etching is better than the wet etching in etching distribution and can anisotropically perform etching, and thus the dry etching is desirable because damage to the area other than the etching area can be reduced. In a case where the support member 16 is removed by the etching process, it is desirable to provide an etching stop layer (not illustrated) between the support member 16 and the polyimide film 25 in order to reduce the risk of damaging the polyimide film 25. The material of the etching stop layer is not particularly limited as long as the material can protect the polyimide film (the flexible member) 25, and, for example, a silicon dioxide (SiO2) film can be used. In a case where the etching stop layer is provided, the etching stop layer is to be removed using a method not damaging the polyimide film (the flexible member) 25 after the etching process of the support member 16 is completed. In a case where an SiO₂ film is used as the material of the etching stop layer, a removal method using, for example, hydrofluoric acid can be employed to remove the etching stop layer.

In a case where the support member 16 is thick, the process of removing the support member 16 using the dry etching and the wet etching takes a long time. Thus, it is desirable to etch the support member 16 after performing a thinning process on the support member 16 using grinding to reduce the thickness of the support member 16. This makes it possible to perform the thinning process of the support member 16 in a short time without damaging the polyimide film (the flexible member) 25 in a case where the support member 16 is thick. In a case where the support member 16 is thin and easy to damage the polyimide film 25, it is possible to remove the support member 16 accurately by performing the etching process.

In a case where the support member 16 is removed by separation, the support member 16 may be separated by forming a separation layer (not illustrated) between the support member 16 and the polyimide film 25 and removing the separation layer after fixing the polyimide film 25 to the first substrate 11.

It is desirable that the surface of the support member 16 in contact with the polyimide film 25 be lower in surface free energy than the surface of the first substrate 11 with the polyimide film 25 formed thereon. In this way, the separation ability of the support member 16 from the polyimide film 25 is improved, and the deformation of the polyimide film 25 during the separation can be suppressed. To suppress the deformation of the polyimide film 25, it is desirable to separate the support member 16 from the polyimide film 25 while bending the support member 16.

A process of removing the polyimide film 25 formed on the first flow path 13 will be described next.

FIG. 1F illustrates a process of forming a photoresist 33, serving as an etching mask, to prevent the polyimide film 25 formed on an area other than an area on the first flow path 13 from being removed.

FIG. 1G illustrates a process of removing the photoresist 33 formed on the first flow path 13 using photolithography. Using photolithography enables exposing the polyimide film 25 only in the area from which the polyimide film 25 is to be removed.

FIG. 1H illustrates a process of removing the polyimide film 25 on the first flow path 13 using etching. This process enables opening the first flow path 13. As the etching method, for example, reactive ion etching using induction coupled plasma (ICP), or chemical dry etching can be used. As an etching gas, it is desirable to use, for example, a mixed gas of an oxygen (O₂) gas and a carbon tetrafluoride (CF₄) gas. After the removal of the polyimide film (the flexible member) 25 on the first flow path 13, the photoresist 33 formed on the area other than the area on the first flow path 13 is removed. At this time, the photoresist 33 may be removed by, for example, separating the photoresist 33 using a photoresist separation liquid, and washing and drying the first substrate 11, or by O₂ ashing.

At last, a second substrate 21 (refer to FIG. 5) is bonded to the first substrate 11 on the side where the polyimide film 25 is formed, to form the second flow path 23 (refer to FIG. 5) that communicates with the polyimide film 25. It is desirable to bond the first substrate 11 and the second substrate 21 with an adhesive agent (not illustrated).

With the processes described above, in the method for manufacturing the flow path member 10, it is possible to reduce the risk of generating wrinkles on the polyimide film 25 because the polyamic acid film 15 arranged to cover the recessed portion 12 is transformed into the polyimide film 25 by thermal imidization reaction in a state of being supported by the support member 16.

FIG. 5 is a schematic cross-section diagram illustrating a liquid discharge head 1 including the flow path member 10 manufactured using the method according to the present exemplary embodiment. The liquid discharge head 1 is manufactured by joining the flow path member 10 and a nozzle plate 2 including discharge ports 3 for discharging a liquid. The liquid discharge head 1 is suitable for an ink jet print head mounted on a recording apparatus for forming text and images on media by discharging ink.

As described above, the flow path member 10 is formed by bonding the first substrate 11 including the recessed portion 12 and the first flow path 13 to the second substrate 21 for forming the second flow path 23 that communicates with the polyimide film (the flexible member) 25. In the first substrate 11, the polyimide film (the flexible member) 25 serving as a damper film for suppressing vibrations of the liquid is formed to cover the recessed portion 12. The second substrate 21 includes, in addition to the second flow path 23, a discharge element 4 for generating a pressure to discharge the liquid from the discharge ports 3, and a pressure chamber 6 in which the pressure generated by the discharge element 4 acts on the liquid. The first substrate 11 and the second substrate 21 are bonded to form the flow path member 10, whereby the liquid flowing through the first flow path 13 is supplied to the pressure chamber 6 via the second flow path 23. The liquid is discharged from the discharge ports 3 by the pressure generated by the discharge element 4 acting on the liquid supplied in the pressure chamber 6.

The discharge element 4 according to the present exemplary embodiment may be a piezoelectric element that deforms when a voltage is applied, or a thermoelectric conversion element that produces heat when a voltage is applied. In a case where the discharge element 4 is a piezoelectric element, it is desirable to provide a vibration plate 5 between the piezoelectric element and the pressure chamber 6. With the vibration plate 5, the deformation of the piezoelectric element can easily transmit to the liquid in the pressure chamber 6. In the inkjet print head including the piezoelectric element, the discharge defect of the liquid discharged from the adjacent discharge ports 3 is likely to occur due to crosstalk, which is a phenomenon in which vibrations transmit to the adjacent discharge ports 3 via the liquid in the second flow path 23. The flow path member 10 according to the present exemplary embodiment includes the polyimide film 25 serving as a damper film. When the vibrations of the discharge element 4 or the vibration plate 5 transmit to the polyimide film 25 via the liquid in the second flow path 23, the polyimide film 25 serving as a damper can suppress the vibrations of the liquid. It is thus possible to suppress the crosstalk by including the polyimide film 25 in the flow path member 10. Accordingly, the flow path member 10 manufactured using the method according to the present exemplary embodiment is suitable for the inkjet print head including the piezoelectric element as the discharge element 4 that is likely to cause the crosstalk.

A method for manufacturing a flow path member according to a second exemplary embodiment will be described. The second exemplary embodiment is different from the first exemplary embodiment in that the polyimide film (the flexible member) 25 is attached to the first substrate 11 instead of imidizing the polyamic acid film 15 after attaching the polyamic acid film 15 to the first substrate 11. In the following description, differences from the first exemplary embodiment will be mainly described, and similarities between the first and second exemplary embodiments will not be described.

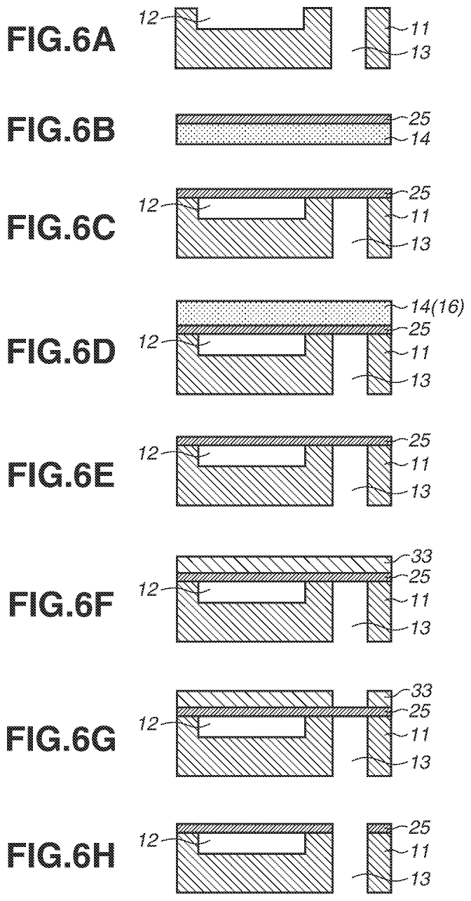

First, as illustrated in FIG. 6A, the first substrate 11 including the recessed portion 12 and the first flow path 13 through which a liquid flows is prepared. The dimensions and shapes of the first substrate 11, the recessed portion 12, and the first flow path 13 can be similar to those in the first exemplary embodiment. It is desirable to prepare the first substrate 11 having the surface (described below) to which the polyimide film 25 is to be attached and a silane coupling agent (not illustrated) is applied and baked. This improves the adhesion between the first substrate 11 and the polyimide film 25.

Next, as illustrated in FIG. 6B, a member with the polyimide film (the flexible member) 25 formed on the attaching member 14 is prepared. In the present exemplary embodiment, the polyimide film (the flexible member) 25 may be a polyamide film or an epoxy resin film instead of a polyimide film. The attaching member 14 may be, for example, a film, a single-crystalline silicon substrate, or a borosilicate glass substrate. In a case where the attaching member 14 is a film, the film may have a roll shape or a sheet shape. Further, for example, the polyimide film 25 may be attached to a frame (not illustrated) made of stainless steel (SUS) with adhesive tape in a non-effective area that is not to be brought into contact with the first substrate 11 in a later process.

Next, as illustrated in FIG. 6C, the polyimide film (the flexible member) 25 for suppressing the vibrations of the liquid in the second flow path 23 is brought into contact with the first substrate 11 including the recessed portion 12 so as to cover the recessed portion 12, via an adhesive agent (not illustrated). It is desirable to bring the polyimide film 25 into contact with the first substrate 11 so as to also cover the first flow path 13. While in the present exemplary embodiment, the polyimide film 25 is brought into contact with the first substrate 11, the first substrate 11 may be brought into contact with the polyimide film (the flexible member) 25. The polyimide film 25 can be brought into contact with the first substrate 11 using the apparatus or conditions similar to those used when the polyamic acid film 15 is attached in the first exemplary embodiment. In the present exemplary embodiment, the term “contact” indicates a state where the polyimide film (the flexible member) 25 and the first substrate 11 are in contact with each other via an uncured adhesive agent (not illustrated).

Next, as illustrated in FIG. 6D, the adhesive agent (not illustrated) is cured. At this time, the adhesive agent is cured in a state where the support member 16 supports an area of the polyimide film 25 that is brought into contact with the first substrate 11 and that covers the recessed portion 12. FIG. 6D illustrates an example in which the attaching member 14 in FIG. 6B is used as the support member 16, but a member different from the attaching member 14 may be used as the support member 16. It is desirable to cure the adhesive agent in a state where the attaching member 14 (the support member 16) also supports an area of the polyimide film 25 that is brought into contact with the first substrate 11 and that covers the first flow path 13. It is possible to suppress the deformation of the polyimide film 25 in the adhesive agent curing treatment, similarly to the process of causing the thermal imidization reaction in the first exemplary embodiment, by curing the adhesive agent in a state where the attaching member 14 (the support member 16) supports the polyimide film 25 on the recessed portion 12 and the first flow path 13.

It is desirable that the adhesive agent includes heat-curing type benzocyclobutene (BCB), but may be any of a photo-curing type adhesive agent and a room-temperature curing type adhesive agent. In the case of the photo-curing type adhesive agent, the support member 16 is desirably made of a material allowing light to pass through and be emitted to the adhesive agent. For example, in a case where the light is ultraviolet light or visible light, a borosilicate glass substrate or a synthesis quartz substrate can be used as the support member 16. In a case where the light is infrared light, for example, a silicon substrate can be used. In the case of the room-temperature curing type adhesive agent, any member usable as the support member 16 can be used without specific limitations.

Next, as illustrated in FIG. 6E, the support member 16 (the attaching member 14) is removed from the polyimide film (the flexible member) 25. The support member 16 is removed using a method similar to that according to the first exemplary embodiment.

Next, as illustrated in FIG. 6F, the photoresist 33 serving as an etching mask is formed to prevent the polyimide film (the flexible member) 25 formed on the area other than the area on the first flow path 13 from being removed.

Next, as illustrated in FIG. 6G, the photoresist 33 formed on the first flow path 13 is removed by photolithography. In this way, the polyimide film 25 can be exposed only in the area from which the polyimide film 25 is to be removed.

Next, as illustrated in FIG. 6H, the polyimide film (the flexible member) 25 on the first flow path 13 is removed by etching. The removal process of the polyimide film (the flexible member) 25 is similar to that in the first exemplary embodiment.

At last, the second substrate 21 (refer to FIG. 5) is bonded to the first substrate 11 on the side with which the polyimide film 25 is brought into contact, to form the second flow path 23 (refer to FIG. 5) that communicates with the polyimide film (the flexible member) 25.

With the processes described above, in the method for manufacturing the flow path member 10, it is possible to reduce the risk of generating wrinkles on the polyimide film (the flexible member) 25 because the adhesive agent is cured in a state where the support member 16 supports the polyimide film (the flexible member) 25 brought into contact with the first substrate 11 via the adhesive agent so as to cover the recessed portion 12.

The liquid discharge head 1 illustrated in FIG. 5 can be manufactured by joining the flow path member 10 manufactured using the method according to the present exemplary embodiment with the nozzle plate 2.

A method for manufacturing the flow path member 10 according to a third exemplary embodiment will be described. The third exemplary embodiment is different from the first and second exemplary embodiments in that the second substrate 21 is used as the support member 16.

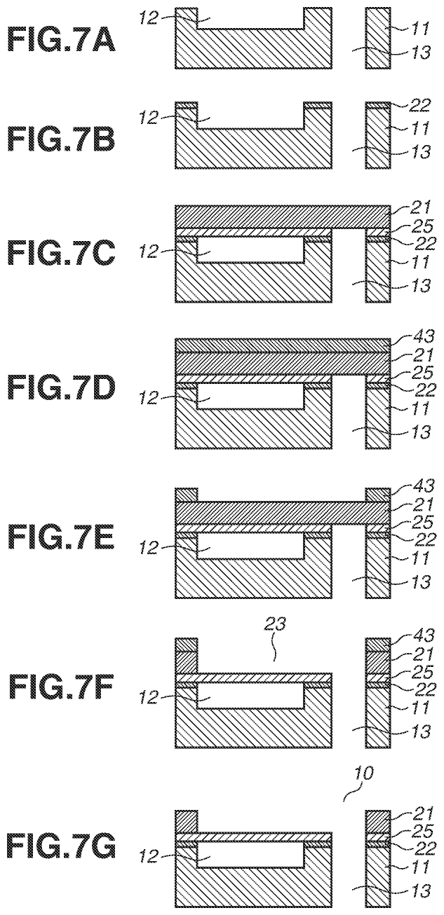

First, as illustrated in FIG. 7A, the first substrate 11 including the recessed portion 12 and the first flow path 13 through which a liquid flows is prepared. The dimensions and shapes of the first substrate 11, the recessed portion 12, and the first flow path 13 can be similar to those in the first exemplary embodiment.

Next, as illustrated in FIG. 7B, an adhesive agent 22 is applied to an area of the first substrate 11 to which the polyimide film (the flexible member) 25 is to be attached.

Next, the polyimide film (the flexible member) 25 is formed on the second substrate 21 in which the second flow path 23 is to be formed in a process described below. As the polyimide film (the flexible member) 25, a polyimide film is desirably used. Then, as illustrated in FIG. 7C, the polyimide film (the flexible member) 25 formed on the second substrate 21 is brought into contact with the first substrate 11 including the recessed portion 12 so as to cover the recessed portion 12, via the adhesive agent 22. Then, the adhesive agent 22 is cured in a state where the second substrate 21 supports the area of the polyimide film 25 that is brought into contact with the first substrate 11 and that covers the recessed portion 12. The adhesive agent 22 is cured using a method similar to that in the second exemplary embodiment. In this way, even in a case where the second substrate 21 is used as the support member 16, it is possible to reduce the risk of generating wrinkles on the polyimide film (the flexible member) 25 by curing the adhesive agent 22 in a state where the second substrate 21 supports the polyimide film (the flexible member) 25.

Next, as illustrated in FIG. 7D, a photoresist 43 for forming the second flow path 23 in the second substrate 21 is formed. The photoresist 43 functions as an etching mask to protect the second substrate 21 in a process (described below) of etching the second substrate 21.

Next, as illustrated in FIG. 7E, the photoresist 43 in an area of the second substrate 21 where the second flow path 23 is to be formed is removed by photolithography. Using photolithography enables exposing only the area of the second substrate 21 where the second flow path 23 is to be formed.

Next, as illustrated in FIG. 7F, the second flow path 23 is formed by etching the area of the second substrate 21 that is not masked by the photoresist 43. The etching method is similar to that used to etch the support member 16 in the first exemplary embodiment.

In the process of etching the second substrate 21, to suppress the risk of etching the polyimide film (the flexible member) 25, it is desirable to provide an etching stop layer (not illustrated). The material of the etching stop layer is not particularly limited as long as the material can protect the polyimide film (the flexible member) 25, and, for example, an SiO₂ layer can be used. In a case where the etching stop layer is provided, after the etching process of the second substrate 21 is completed, the etching stop layer is to be removed using a method not damaging the polyimide film (the flexible member) 25. In a case where the SiO2 layer is used as the etching stop layer, the etching stop layer is removed, for example, using hydrofluoric acid.

Next, as illustrated in FIG. 7G, the photoresist 43 remaining on the second substrate 21 is removed. The photoresist 43 can be removed using a method similar to the method for removing the photoresist 33 in the first exemplary embodiment.

Through the processes described above, the flow path member 10 can be manufactured. Like the processes described above, even in a case where the second substrate 21 is used as the support member 16, it is possible to manufacture the flow path member 10 while suppressing the generation of wrinkles on the polyimide film 25 that is arranged to cover the recessed portion 12. By using the second substrate 21 as the support member 16, it is also possible to manufacture the flow path member 10 in a takt time shorter than that according to the first and second exemplary embodiments.

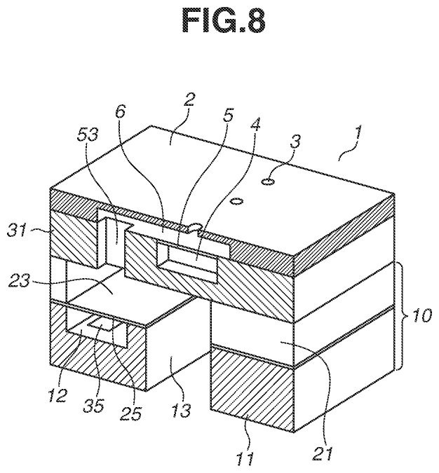

FIG. 8 is a schematic cross-section diagram illustrating the liquid discharge head 1 including the flow path member 10 manufactured using the method according to the present exemplary embodiment. The liquid discharge head 1 according to the present exemplary embodiment is different from that according to the first exemplary embodiment in that a third substrate 31 includes the discharge element 4 and the pressure chamber 6 instead of the second substrate 21. The third substrate 31 includes a third flow path 53 communicating with the second flow path 23, and the second flow path 23 and the pressure chamber 6 are connected to each other via the third flow path 53. The liquid discharge head 1 according to the present exemplary embodiment is manufactured by joining the flow path member 10, the third substrate 31, and the nozzle plate 2 including the discharge ports 3.

Configurations obtained by combining the configurations according to the above-described exemplary embodiments as appropriate are also applicable.

### Example 1

Example 1 will be described next. In Example 1, the flow path member 10 was manufactured using the method according to the first exemplary embodiment. First, as illustrated in FIG. 1A, the first substrate 11 including the recessed portion 12 and the first flow path 13 was prepared. The first substrate 11 was made of single crystal silicon with both sides ground, and 500 μm in thickness. The width of the recessed portion 12 in a short-side direction thereof was 600 μm, and the width of the first flow path 13 in a short-side direction thereof was 300 μm. The air communication hole 35 was formed in the recessed portion 12. As silane coupling treatment (not illustrated), a silane coupling agent was applied by spraying to the surface of the first substrate 11 to which the polyamic acid film 15 is to be attached, and then baked before the polyamic acid film 15 is attached thereto.

Next, as illustrated in FIG. 1B, after the polyamic acid film 15 was spin coated on the attaching member 14 made of a polyethylene terephthalate (PET) film of 100 μm in thickness, the polyamic acid film 15 was pre-baked at 100° C. in a clean oven to form the polyamic acid film 15 having a film thickness of 5 μm. Release treatment was applied to the surface of the attaching member 14 to make it easy to separate the polyamic acid film 15 therefrom.

Next, as illustrated in FIG. 1C, the polyamic acid film 15 was attached to the first substrate 11 so as to cover the recessed portion 12 and the first flow path 13. The polyamic acid film 15 was attached using a roller method capable of pressing and heating. Next, the attaching member 14 was separated from the attached polyamic acid film 15 while being bent.

Next, as illustrated in FIG. 1D, the polyamic acid film 15 attached to the first substrate 11 was baked for imidization while being supported by the support member 16. A silicon substrate was used as the support member 16. The baking for imidization was performed for one hour at 350° C. in a nitrogen atmosphere. The polyamic acid film 15 on the recessed portion 12 and the first flow path 13 was heated while being supported by the support member 16, whereby the generation of the deformation and wrinkles on the polyamic acid film 15 (the polyimide film 25) during the heat treatment was suppressed. Through the heat treatment, the polyamic acid film 15 was transformed into the polyimide film 25 by thermal imidization reaction.

Next, as illustrated in FIG. 1E, after the thinning process of the support member 16 using grinding, the support member 16 was removed by etching. In this way, the flow path member 10 including the polyimide film 25 serving as a damper film and arranged to cover the recessed portion 12 and the first flow path 13 was formed.

Next, as illustrated in FIG. 1F, to prevent the polyimide film 25 formed on the area other than the area on the first flow path 13 from being removed, the photoresist 33 of positive type, serving as an etching mask, was formed.

Next, as illustrated in FIG. 1G, the photoresist 33 formed on the first flow path 13 was removed by photolithography.

Next, as illustrated in FIG. 1H, the polyimide film 25 on the first flow path 13 was removed by chemical dry etching. A mixed gas of an O₂ gas and a CF₄ gas was used as an etching gas. After the dry etching, the etching mask is removed using an oxygen ashing method.

At last, the first substrate 11 and the second substrate 21 were bonded together with an adhesive agent.

As described above, the flow path member 10 was successfully manufactured while suppressing the generation of wrinkles on the polyimide film 25 serving as a damper film.

### Example 2

Example 2 will be described next. In Example 2, the flow path member 10 was manufactured using the method according to the second exemplary embodiment.

In Example 2, differences from the first exemplary embodiment will be mainly described, and similarities between the first and second exemplary embodiments will not be described.

As illustrated in FIG. 6A, the first substrate 11 including the recessed portion 12 and the first flow path 13 was prepared.

As illustrated in FIG. 6B, a member including the attaching member 14 with the polyimide film 25 formed thereon was prepared. The thickness of the polyimide film 25 was 5 μm. The attaching member 14 was a frame made of SUS, and the polyimide film 25 and the frame made of SUS were attached and fixed with adhesive tape in the non-effective area.

As illustrated in FIG. 6C, the polyimide film 25 was brought into contact with the first substrate 11 including the recessed portion 12 and the first flow path 13. An adhesive agent (not illustrated) having a film thickness of 1.5 μm and including BCB was applied to the contact surface of the first substrate 11 before the polyimide film 25 was attached to the first substrate 11. The polyimide film 25 was brought into contact with the first substrate 11 using a roller method capable of pressing and heating. After the attachment, the polyimide film 25 was cut out to match the external shape of the first substrate 11.

Next, as illustrated in FIG. 6D, the adhesive agent was cured by heat while the support member 16 supports the polyimide film 25 laminated on the first substrate 11. A silicon substrate was used as the support member 16. The curing was performed for one hour at a heating temperature of 250° C. in an inert state in a nitrogen atmosphere while a pressure was applied from the support member 16 side by a bonding apparatus (not illustrated). Because the adhesive agent was heated and cured while the polyimide film 25 on the recessed portion 12 and the first flow path 13 was supported by the support member 16, the deformation of the polyimide film 25 due to the deformation of the adhesive agent and the warp of the first substrate 11 during the heating and curing was suppressed.

Next, as illustrated in FIG. 6E, after the thinning process of the support member 16 using grinding, the support member 16 was removed by etching. In this way, the flow path member 10 including the polyimide film 25 serving as a damper film and arranged to cover the recessed portion 12 and the first flow path 13 was formed.

In the subsequent processes, the flow path member 10 was manufactured using a method similar to the method according to the first exemplary embodiment. As a result, the flow path member 10 was successfully manufactured while suppressing the generation of wrinkles on the polyimide film 25 serving as a damper film.

According to the above-described exemplary embodiments, it is possible to provide a method for manufacturing a flow path member while suppressing generation of wrinkles on a flexible member that is arranged to cover a recessed portion.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-136399, filed Aug. 30, 2022 and Japanese Patent Application No. 2023-097285, filed Jun. 13, 2023, each of which is hereby incorporated by reference herein in its entirety.

What is claimed is:

1. A method for manufacturing a flow path member, the method comprising:
bringing a flexible member into contact with a first substrate including a recessed portion via an adhesive agent so as to cover the recessed portion, wherein the flexible member is configured to suppress vibrations of a liquid in a flow path;
curing the adhesive agent in a state where at least an area of the flexible member covering the recessed portion is supported by a support member;
bonding a second substrate to a side of the first substrate with which the flexible member is brought into contact, wherein the second substrate is configured to form the flow path facing the flexible member; and
removing the support member from the flexible member in a period after the curing and before the bonding.

2. The method according to claim 1, wherein the adhesive agent is cured by heat in the curing.

3. The method according to claim 2, wherein a glass transition temperature of the support member is higher than a heating temperature in the curing.

4. The method according to claim 2, wherein a difference between a linear expansion coefficient of the support member and a linear expansion coefficient of the flexible member is 50 parts per million (ppm)/° C. or less.

5. The method according to claim 1, wherein the adhesive agent is cured by light in the curing.

6. The method according to claim 1, wherein the removing includes a thinning process for reducing a thickness of the support member.

7. The method according to claim 6, wherein the thickness of the support member is reduced by grinding in the thinning process.

8. The method according to claim 1, wherein the removing includes an etching process.

9. The method according to claim 8, wherein a silicon dioxide (SiO₂) film is formed between the support member and the flexible member.

10. The method according to claim 1, wherein, in the removing, the support member is removed by etching after a thickness of the support member is reduced by grinding.

11. The method according to claim 1, wherein stiffness of the support member is higher than or equal to stiffness of the flexible member.

12. The method according to claim 1, wherein a thickness of the support member is greater than or equal to a thickness of the flexible member.

13. The method according to claim 1, wherein the flexible member is a polyimide film.

14. The method according to claim 1, wherein the support member is a silicon substrate.

15. The method according to claim 1, wherein the adhesive agent includes benzocyclobutene.

16. The method according to claim 1, wherein, in a case where the flow path member is included in a liquid discharge head, the flow path member is a member for supplying the liquid to a nozzle plate including a discharge port for discharging the liquid.

17. A method for manufacturing a flow path member, the method comprising:
attaching a polyamic acid film to a first substrate including a recessed portion so as to cover the recessed portion;
transforming the polyamic acid film attached to the first substrate into a polyimide film by thermal reaction, wherein the polyimide film is configured to suppress vibrations of a liquid in a flow path; and
bonding a second substrate to a side of the first substrate on which the polyimide film is formed, wherein the second substrate is configured to form the flow path facing the polyimide film,
wherein the transforming includes heating at least an area of the polyamic acid film covering the recessed portion in a state of being supported by a support member, and
wherein the support member is removed from the polyimide film in a period after the transforming and before the bonding.

18. The method according to claim 17, wherein the support member includes a groove portion on a part of a surface of the support member that is in contact with the polyamic acid film.

19. The method according to claim 17, wherein a silane coupling agent is applied to a surface of the first substrate to which the polyamic acid film is to be attached.

20. The method according to claim 17, wherein, in a case where the flow path member is included in a liquid discharge head, the flow path member is a member for supplying the liquid to a nozzle plate including a discharge port for discharging the liquid.
